(19) United States
(12) Patent Application Publication
(10) Pub. No.: US 2012/0186894 A1
(43) Pub. Date: Jul. 26, 2012

(54) EXHAUST GAS SYSTEM FOR A BUILDING MACHINE

(75) Inventors: Thomas Schmidt, Plankstadt (DE); Christian Pawlik, Neustadt (DE); Philipp Stumpf, Heidelberg (DE)

(73) Assignee: JOSEPH VOGELE AG, Ludwigshafen (DE)

(21) Appl. No.: 13/350,004

(22) Filed: Jan. 13, 2012

(30) Foreign Application Priority Data
Jan. 25, 2011 (EP) 11000585.7

(51) Int. Cl. B60K 13/04

(52) U.S. Cl. 180/309

(57) ABSTRACT

The invention relates to an exhaust gas system for a building machine, specifically for a road finishing machine or a feeder, comprising an engine compartment with an engine hood, and an exhaust gas pipe which carries off combustion gases from the engine, wherein the exhaust gas pipe is mounted in the engine compartment and ends underneath the engine hood.

The present invention relates to an exhaust gas system for a building machine, specifically for a road finishing machine or a charger.

In the field of road construction road finishing machines and charging vehicles are used for paving surfaces. Known road finishing machines and charging vehicles are driven by an internal combustion engine. As is generally known, the exhaust gases of the internal combustion engine are blown out through a long exhaust gas tail pipe at the height of the drivers roof so as to keep the exhaust gases away from the operating staff. Usually, the exhaust gas tail pipe is mounted on a muffler and, together with the muffler, is vertically fixed on the engine hood in front of the control platform.

The problem involved by the above construction is that the exhaust gas tail pipe and the muffler associated therewith obstruct the view of the operating staff present on the control platform. Moreover, the exhaust gas tail pipe and the muffler, which are both directed toward the outside, are exposed to any weather conditions so that, in practice, the exhaust gas pipe and the muffler are frequently damaged as a result of corrosion.

Furthermore, road finishing machines and charging vehicles are known in practice, whose exhaust gas pipe is arranged on the engine hood of the building machine in a pluggable or foldable manner. Consequently, for the transport of the road finishing machine on a low-bed trailer, the tail pipe can be removed or folded up in such a way that a corresponding transport height is observed.

However, despite the pluggable or foldable exhaust gas tail pipe, in has shown in practice that movable devices of this type are easily damaged. Often, the exhaust gas tail pipe and the muffler suffer from rust to such an extent that it is difficult or even impossible for the operating staff to remove the exhaust gas tail pipe or fold it up. Also, a removable or foldable exhaust gas tail pipe is relatively expensive, and it requires additional know how for the mounting thereof in order to guarantee a proper exhaust gas emission.

The invention is based on the object to improve an exhaust gas system for a building machine, or a building machine comprising such an exhaust gas system by means of simple constructive features to the effect that as many of the above-described drawbacks as possible are avoided.

This object is achieved by providing the building machine with an engine compartment with an engine hood, and an exhaust gas pipe which carries off combustion gases from the engine, wherein the exhaust gas pipe is mounted in the engine compartment and ends underneath the engine hood.

According to the invention the exhaust gas pipe is not mounted on the engine hood of the building machine. By contrast, according to the invention, the exhaust gas pipe is mounted in the engine compartment, with the exhaust gas pipe ending underneath the engine hood.

As, according to the invention, the exhaust gas pipe already ends underneath the engine hood the operator has an improved view during the operation of the building machine. Moreover, the exhaust gas pipe underneath the engine hood can be protected against dirt and bad weather conditions, which can improve the functionality of the exhaust gas pipe and increase the service life. In addition, the exhaust gas pipe mounted in the engine compartment is not subject to the risk of getting damaged during transport. Also, complicated and expensive foldable or pluggable devices for the exhaust gas pipe can be waived.

Preferably, the exhaust gas pipe comprises at least one exhaust gas outlet port which provides the exhaust gas flow with a flowout direction and likewise ends underneath the engine hood. Through the exhaust gas outlet port a limited and precise amount of exhaust gases can flow out of the engine compartment of the building machine.

In another embodiment an exhaust gas outlet opening is provided in the engine hood, which is oriented fluidically (i.e. in fluid alignment) with the exhaust gas pipe or with the exhaust gas outlet port. The exhaust gas outlet opening provided in the engine hood ensures that the combustion gases flow out through the engine hood without any problems.

In a useful embodiment the exhaust gas outlet port or the exhaust gas pipe end in the exhaust gas outlet opening. By this it is achieved that the outflowing exhaust gases are completely conducted into the exhaust gas outlet opening by the exhaust gas pipe or exhaust gas outlet port.

Also, it is advantageous if at least one hot air opening is provided in the engine hood for the outlet of rejected heat of the engine. This prevents the engine from overheating and being damaged.

In another useful embodiment the at least one hot air opening comprises flow fins in order to provide an outflowing flow of heated air with a flowout direction.

Preferably the exhaust gas outlet opening is arranged next to the hot air opening. By this it is achieved that the exhaust gas flow is conducted into the hot air flow so that an efficient transport of the exhaust gases out of the building machine can be obtained.

In another embodiment the exhaust gas system comprises at least one cooling fan which is provided to cool the engine. Also, it is an advantage if the cooling fan is speed-controlled. A sufficient cooling air flow is obtained if the cooling fan does not fall below a minimum speed.

In a useful embodiment an air flow produced by the cooling fan is provided to carry off the engine heat, wherein the air flow from the cooling fan, heated by the engine heat, forms a hot air flow for carrying off the combustion gases of the engine. When the hot air flow flows out of the hot air opening, which is formed in the engine hood, the hot air flow encounters the exhaust gas flow from the exhaust gas outlet opening, envelopes and dilutes the same, and conducts it out of the exhaust gas outlet opening and away from the operating staff.

Preferably, a diffuser is provided, which may be employed to dilute and cool the combustion gases. The diffuser allows the exhaust gases to relax and cool down right after they have flown out of the internal combustion engine, so that an excessive heating of the exhaust gas pipe is avoided. Moreover, the diffuser allows an improved removal of generated engine heat, while the cooled exhaust gases emitted by the diffuser do not unnecessarily heat the ambient temperature of the engine of the building machine.

Also, it is an advantage if the exhaust gas pipe is connected to an exhaust gas aftertreatment device. The exhaust gas aftertreatment device is able to expand and slow down the exhaust gas flow and attenuate the oscillations thereof. The exhaust gas aftertreatment device may comprise a particle filter, a catalyst, a muffler etc.

In order to reduce a noise emission of the exhaust gas system the exhaust gas aftertreatment device is preferably mounted in the engine compartment of the building machine. Thus, it is also possible to protect the exhaust gas aftertreatment device against bad weather influences.

The exhaust gas system according to the invention may be used for any building machine. Preferably, road finishing machines or feeder vehicles are equipped with such an exhaust gas system.

Below, the invention will be explained by means of the accompanying figures, wherein

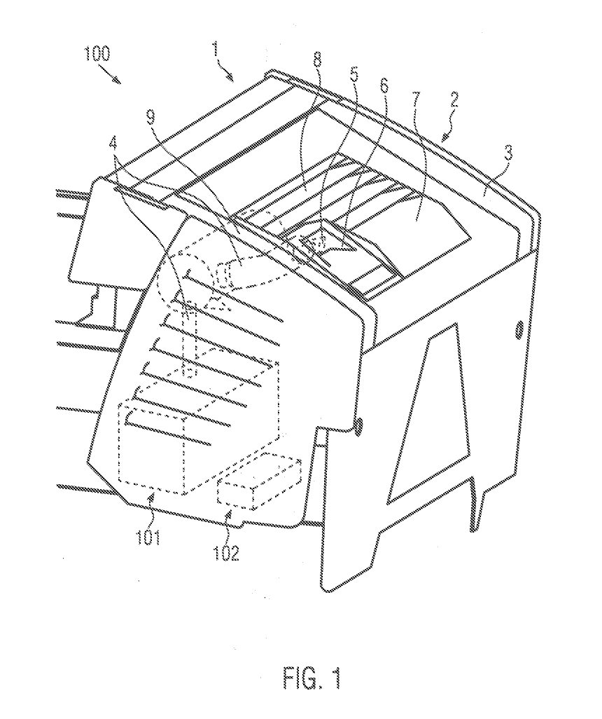

FIG. 1 shows an embodiment according to the invention, and

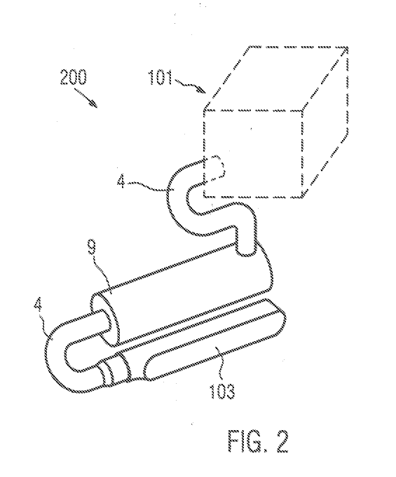

FIG. 2 shows an engine arrangement used for the invention.

FIG. 1 shows a section of a building machine 100, which comprises an exhaust gas system 1 according to the invention. In particular, the building machine 100 is a road finishing machine or a feeder.

The exhaust gas system 1 comprises an engine compartment 2 with an engine hood 3. An internal combustion engine 101 for driving the building machine 100 is mounted in the engine compartment 2. An exhaust gas pipe 4 is positioned in the engine compartment 2 underneath the engine hood 3. The exhaust gas pipe 4 extends upwardly towards an upper surface of the engine hood 3, but does not project out of the engine hood 3.

At an upper end of the exhaust gas pipe 4 exhaust gas outlet ports 5 are provided, by means of which a direction of the exhaust gas flow can be determined as it flows out of the exhaust gas system. The exhaust gas outlet ports 5 are arranged side by side, but may also be arranged on the exhaust gas pipe 4 in any other optional formation. Moreover, it is possible to provide the exhaust gas outlet ports 5 with different diameters and different heights.

FIG. 1 also shows that an exhaust gas outlet opening 6 is provided in the engine hood 3, which is oriented fluidically with the exhaust gas pipe 4 or, in this case, with the exhaust gas outlet port 5. The exhaust gas outlet opening 6 has such a shape that an exhaust gas flow is conducted forwards, away from the engine hood 3 and, therefore, also away from the operating staff.

It can also be seen in FIG. 1 that the exhaust gas outlet ports 5 end in the exhaust gas outlet opening 6. Although not shown in FIG. 1, it may be that the exhaust gas outlet ports 5 project into the exhaust gas outlet opening 6 over a certain length without essentially projecting out of the engine hood 3.

Moreover, a hot air opening 7 is provided in the engine hood 3, which is connected fluidically to a cooling fan 102. The cooling fan 102 transports the rejected heat of the engine 101 to the hot air opening 7, where the cooling air flow flows out of the engine compartment 2 in form of a hot air flow. In terms of the surface area the hot air opening 7 covers a greater part of the surface of the engine hood 3 than the exhaust gas outlet opening 6. The exhaust gas outlet opening 6 is located in a lower left portion of the hot air opening 7.

As is shown by FIG. 1, the hot air opening 7 comprises flow fins 8 which are arranged in parallel in the hot air opening 7. The flow fins 8 adopt an inclined position in order to conduct the heated air flow forwards, away from the engine hood 3.

The exhaust gas outlet opening 6 is adjacent along two sides of the hot air opening 7, wherein the exhaust gas outlet opening 6 is arranged in front of and next to some flow fins 8 so that the hot air flow carries the exhaust gas flow flowing out of the exhaust gas opening 6 forwards, away from the engine hood 3, as it flows out of the hot air opening 7. It is also provided that the hot air flow conducted by the upper flow fins 8 flows out above the exhaust gas outlet opening 6, thereby covering the exhaust gases flowing out of the exhaust gas outlet opening 6, so that the exhaust gases are kept away from the operating staff.

Moreover, an exhaust gas aftertreatment device 9 is flanged to the exhaust gas pipe 4. The exhaust gas aftertreatment device 9 is located inside the engine compartment 2, underneath the engine hood 3. Together with the exhaust gas pipe 4 the exhaust gas aftertreatment device 9, which comprises, for example, a particle filter, a catalyst, a muffler etc., ensures an optimum transport of the exhaust gases away from the internal combustion engine.

FIG. 2 shows an engine arrangement 200 as is usable for a building machine 100 according to the invention. In addition to the embodiment shown in FIG. 1, FIG. 2 shows a diffuser 103 which is connected by the exhaust gas pipe 4 to the exhaust gas aftertreatment device 9. The diffuser 103 is provided to dilute and cool down the combustion gases. Although the engine arrangement 200 of FIG. 2 is not shown as being installed in the engine compartment, according to the invention, the diffuser is oriented fluidically with the exhaust gas outlet opening 6 shown in FIG. 1 and does not project out of the latter.

The exhaust gas system 1 according to the invention can be used for any type of building machine. Moreover, the exhaust gas system 1 can be employed for the efficient transport of exhaust gas in agricultural machines and trucks.

1. Exhaust gas system for a building machine, specifically for a road finishing machine or a feeder, comprising:
an engine compartment with an engine hood, and
an exhaust gas pipe which carries off combustion gases from the engine,
wherein
the exhaust gas pipe is mounted in the engine compartment and ends underneath the engine hood.

2. Exhaust gas system according to claim 1, wherein the exhaust gas pipe comprises at least one exhaust gas outlet port which provides the exhaust gas flow with a flowout direction and ends underneath the engine hood.

3. Exhaust gas system according to claim 1, wherein an exhaust gas outlet opening is provided in the engine hood, which is oriented fluidically with the exhaust gas pipe or with the exhaust gas outlet port.

4. Exhaust gas system according to claim 2, wherein the exhaust gas outlet port or the exhaust gas pipe end in the exhaust gas outlet opening.

5. Exhaust gas system according to claim 1, wherein at least one hot air opening is provided in the engine hood for the outlet of heated air of the engine.

6. Exhaust gas system according to claim 5, wherein the at least one hot air opening comprises flow fins in order to provide an outflowing flow of heated air with a flowout direction.

7. Exhaust gas system according to claim 5, wherein the exhaust gas outlet opening is arranged next to the hot air opening so as to conduct the exhaust gas flow into the heated air flow.

8. Exhaust gas system according to claim 1, wherein at least one cooling fan which is provided to cool the engine.

9. Exhaust gas system according to claim 8, wherein the cooling fan is speed-controlled so as to ensure a sufficient cooling capacity.

10. Exhaust gas system according to claim 8, wherein the cooling fan does not fall below a minimum speed.

11. Exhaust gas system according to claim 8, wherein an air flow produced by the cooling fan is provided to carry off the engine heat, wherein the air flow from the cooling fan, heated by the engine heat, forms an heated air flow for carrying off the combustion gases of the engine.

12. Exhaust gas system according to claim 1, wherein a diffuser which is provided to dilute and cool the combustion gases.

13. Exhaust gas system according to claim 1, wherein an exhaust gas aftertreatment device which is connected to the exhaust gas pipe.

14. Exhaust gas system according to claim 13, wherein the exhaust gas aftertreatment device is mounted in the engine compartment of the building machine.

15. Road finishing machine or charger comprising an exhaust gas system according to claim 1.
